(19) United States
(12) Patent Application Publication
(10) Pub. No.: US 2019/0008278 A1
(43) Pub. Date: Jan. 10, 2019

(54) OVERTURN PREVENTING DEVICE

(71) Applicant: KYB CORPORATION, Minato-ku, Tokyo (JP)

(72) Inventor: Masaya UNE, Minato-ku, Tokyo (JP)

(73) Assignee: KYB CORPORATION, Minato-ku, Tokyo (JP)

(21) Appl. No.: 16/068,978

(22) PCT Filed: Jan. 5, 2017
(86) PCT No.: PCT/JP2017/000115

§ 371 Date: Jul. 10, 2018

(30) Foreign Application Priority Data
Jan. 13, 2016 (JP) 2016-004042

(51) Int. Cl. A47B 97/00; F16F 9/06

(52) U.S. Cl. CPC A47B 97/00; F16F 9/516; A47B 2097/008; F16F 9/061

(57) ABSTRACT

The overturn preventing device includes a damper, a length adjusting member and a pair of bases. The damper has a cylinder having an outer peripheral surface formed with a screw thread, and a rod. The cylinder is bottomed. The rod is inserted. into the cylinder and has a distal end protruding out of an open end of the cylinder. The length adjusting member has a first end and a second end. The first end has an opening. The length adjusting member has an inner peripheral surface formed with a screw thread so that the cylinder is screwed through the first end into the length adjusting member. The bases are rotatably coupled to the second end of the length adjusting member and the distal end of the rod respectively. The bases abut against a top surface of an article installed. on an installation surface and a ceiling respectively.

### TECHNICAL FIELD

The present invention relates to an overturn preventing device which prevents furniture and the like from overturn.

### BACKGROUND ART

Patent Document 1 discloses a conventional overturn preventing device. The overturn preventing device includes a pair of bases, a support pillar and an operating member . The bases are respectively caused to abut against a ceiling and a top surface of an article, The support pillar includes an outer cylinder, an inner cylinder and a helical extension spring. The outer and inner cylinders are each formed into a cylindrical shape. The inner cylinder is movably inserted through an interior of the outer cylinder. The inner cylinder has an upper end coupled to one of the bases. The outer cylinder has a lower end coupled to the other base. The spring is inserted through the inner cylinder and has two ends respectively coupled to a lower end of the inner cylinder and an upper end of the outer cylinder. In other words, the spring imparts an elastic force to the inner cylinder so that the inner cylinder protrudes to an upper side of the outer cylinder. The operating member includes a pressing frame member and an operating lever. The pressing frame member is provided on the upper end of the outer peripheral surface of the outer cylinder. The operating lever is formed into the shape of a bar extending in one direction. The operating lever has two ends one of which is coupled to the pressing frame member.

In this overturn preventing device, the other end of the operating lever is operated so that the upper end of the outer cylinder is tightened by the pressing frame member, with the result that a part of the inner cylinder protruding from the outer cylinder can be held at a desired dimension. Furthermore, the dimension can be changed freely by operating the operating lever to release the upper end of the outer cylinder from the tightening by the pressing frame member. In other words, an overall length of the overturn preventing device can easily be adjusted by operating the operating lever of the operating member. As a result, the overturn preventing device can be mounted by adjusting the overall length thereof suitable to a dimension between the ceiling and the top surface of the article even when the articles have different heights with the result that the dimension between the ceiling and the top surface of the article differs from one case to another, whereby the article can be prevented from overturn.

### PRIOR ART DOCUMENT

### Patent Documents

Patent Document 1: Japanese Patent Application Publication No. JP 2013-94653

### SUMMARY OF THE INVENTION

### Problem to Be Overcome by the Invention

In the overturn preventing device of Patent Document 1, however, the dimension of the part of the inner cylinder protruding out of the outer cylinder is maintained by tightening the upper end of the outer cylinder by the pressing frame member. Accordingly, when an earthquake occurs under the condition where the overturn preventing device is mounted between the ceiling and the top surface of the article, the article is vibrated by shaking of the earthquake, so that the overturn preventing device is compressed by the ceiling and the top surface of the article. As a result, the inner cylinder is pushed into the outer cylinder with the result that the overall length of the overturn preventing device is reduced, so that the overturn preventing device has a possibility of falling from between the ceiling and the top surface of the article.

### Means for Overcoming the Problem

The present invention was made in view of the above-described circumstances in the conventional art and has an object to provide an overturn preventing device which can successfully prevent the article from overturn or displacement due to shaking of earthquake.

The overturn preventing device in accordance with the invention includes a damper, a length adjusting member and a pair of bases. The damper has an outer peripheral surface formed with a screw thread. The damper has a cylinder and a rod. The cylinder is bottomed and has two ends one of which is an open end and the other of which is a closed end. The rod is inserted, into the cylinder and has a distal end protruding out of the open end of the cylinder, The length adjusting member has a first end and a second end. The first end has an opening. The length adjusting member has an inner peripheral surface formed with a screw thread so that the cylinder is screwed through the first end into the length adjusting member. The bases are rotatably coupled to the second end of the length adjusting member and the distal end of the rod respectively. The bases abut against a top surface of an article installed on an installation surface and a ceiling respectively.

The cylinder in the invention may include a cylinder body into which the rod is inserted, and a screw member into which the cylinder body is inserted to be fixed, The screw member has an outer peripheral surface formed with a screw thread thereby to be screwed into the length adjusting member.

The overturn preventing device may further include a nut member screwed onto the cylinder and abutting against the first end of the length adjusting member.

The base in the invention may have a friction member which abuts against the ceiling or the top surface of the article.

In the overturn preventing device in accordance with the invention, when the damper is screwed deepest into the length adjusting member and the damper is contracted most, an upper end of the length adjusting member may be level with or be located lower than a lower end of a rod-side joint of the damper.

The overturn preventing device in accordance with the invention may further include a stopping member which stops the damper from extension. The damper may be a fluid pressure damper which encloses an operating fluid in the cylinder and has a piston which is housed in the cylinder to be slidable in a direction of a central axis of the cylinder and to which a proximal end of the rod is coupled. In the damper while the rod is disposed at an upper side thereof and the cylinder is disposed at a lower side thereof, the stopping member may stop the damper from extension at a length of the damper not more than a length when the piston is located at an upper end in the hydraulic fluid in the cylinder.

in the overturn preventing device in accordance with the invention, the stopping member may stop the damper from extension at a middle length of the damper between the length when where the piston is located at the upper end in the hydraulic fluid and another length when the piston is located at a lower end in the hydraulic fluid.

The article includes furniture, book shelves, refrigerators, showcases, server racks, a bed having a plurality of beds connected to each other in the up-down direction, and large sized televisions, and the like all of which have a possibility of being overturned by shaking of earthquake or the like.

### BRIEF DESCRIPTION OF THE DRAWINGS

FIGS. 1(A) and 1(B) are side views of the overturn preventing device of a first embodiment, FIG. 1(A) illustrating a cylinder most deeply screwed into a length adjusting member and FIG. 1(B) illustrating the cylinder most shallowly screwed into the length adjusting member;

FIG. 2 is a side view of the overturn preventing device of the first embodiment mounted between the ceiling and the top surface of the furniture;

FIG. 3 is also a side view of the overturn preventing device of the first embodiment mounted between the ceiling and the top surface of the furniture illustrating a state where a distance between the ceiling and the top surface of the furniture is longer than in FIG. 2;

FIG. 4 is a front view illustrating a pair of the overturn preventing devices of the first embodiment mounted between the ceiling and the top surface of the furniture; and

FIG. 5 is a side view of the overturn preventing device of a second embodiment.

### BEST MODE FOR CARRYING OUT THE INVENTION

A first embodiment of the overturn preventing device of the present invention will be described with reference to the drawings.

### First Embodiment

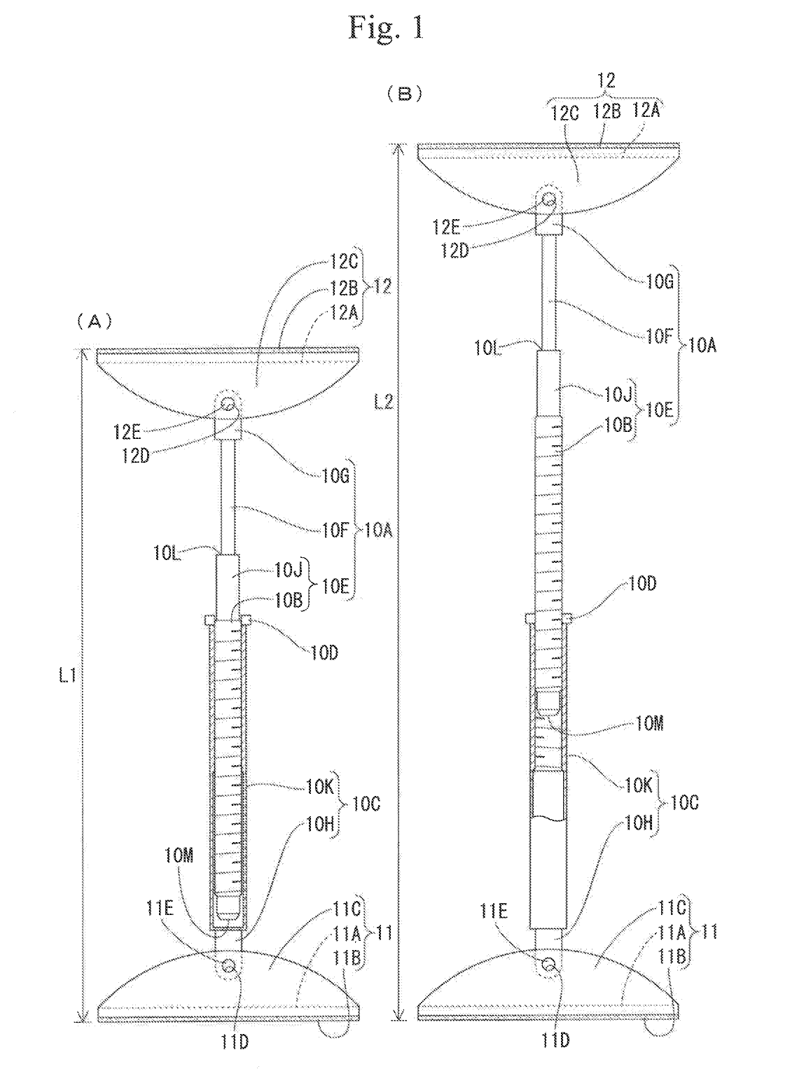

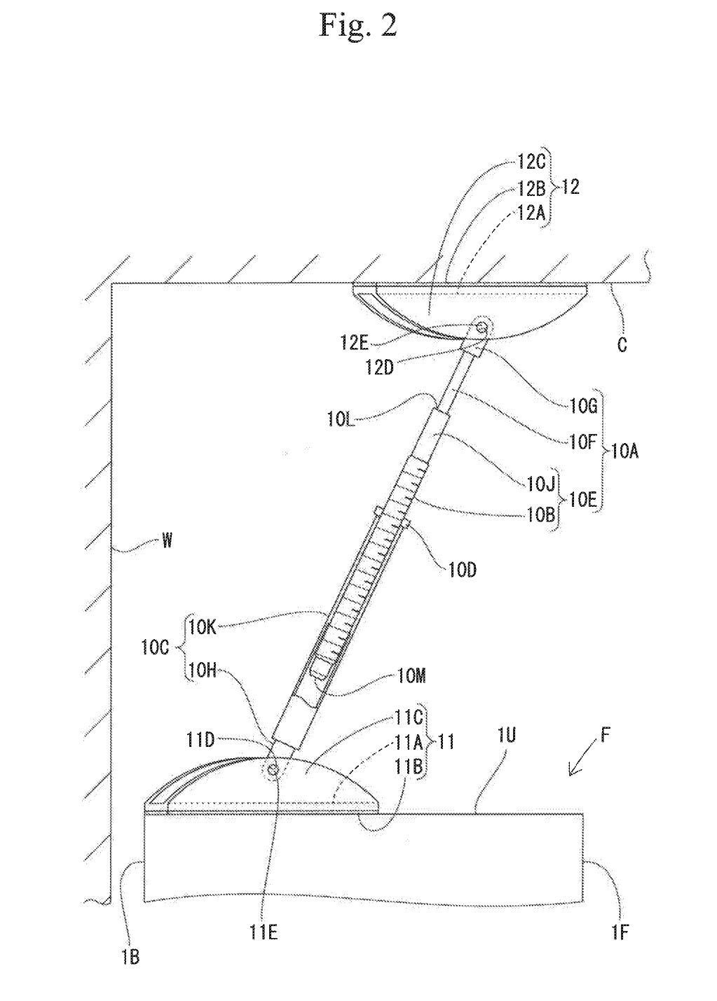

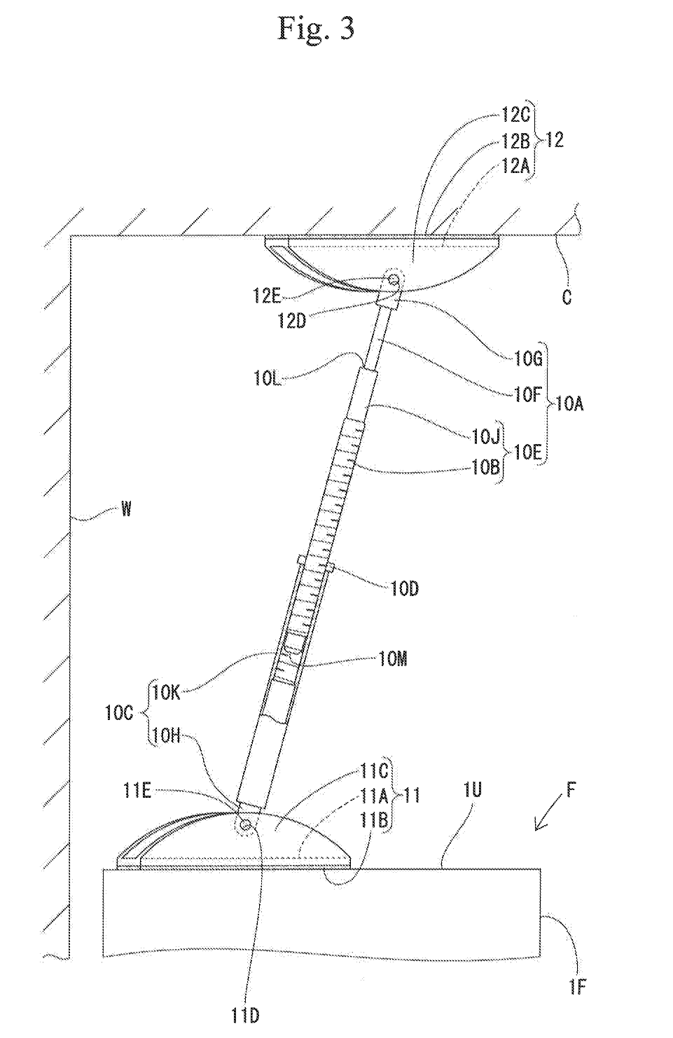

An overturn preventing device 1 of the first embodiment is mounted between a top surface 1U (the upper side as viewed in FIG. 2 and the same shall hereinaf ter apply) of a piece of furniture F and a ceiling C, as illustrated in FIGS. 2 and 3. The furniture F serves as an article installed on an installation surface (not. illustrated) with a back surface 1B thereof (the back is a left side as viewed in FIG. 2 and the same shall hereinafter apply) being opposed to a wall surface W extending vertically from the installation surface. The furniture F is formed into a rectangular parallelepiped shape and has a door, drawers (neither illustrated) and the like in the front surface 1F (the front is a right side as viewed in FIG. 1 and the same shall hereinafter appy), so that clothes, accessories and the like can be housed in the furniture F. The furniture F has a rectangle-shaped horizontal section long in a right-left direction (the right-left is a depthwise direction in FIG. 2 and the same shall hereinafter apply) When the overturn preventing device is not mounted on the furniture 1, the furniture 1. would possibly be tilted forward by shaking of earthquake or the like thereby to be overturned.

The overturn preventing device includes a damper 10.A, a length adjusting member 10C, a nut member 10D, a first base 11 and a second. base 12 as illustrated in FIGS. 1(A) and 1(B)

The damper 10A includes a cylinder 10E, a rod guide (not illustrated), a piston (not illustrated), a rod 10F and a rod-side joint 10G. The cylinder 10E includes a cylinder body 10J and a screw member 10B. The cylinder body 10J is formed into a bottomed cylindrical shape. The cylinder body 10J has two ends one of which is formed into an open end 10L. The other end of the cylinder body 10J is formed into a closed end 10M. In other words, the cylinder 10E has two ends one of which is the open end 10L and the other of which is the closed end 10M.

The screw member 10B has two open ends and extends into a cylindrical shape. The screw member 10B has a dimension in the central axis direction slightly smaller than that of the cylinder body 10J. The screw member 10B is formed with a screw thread over an entire outer peripheral surface thereof in the central axis direction. The screw member 10B into which the cylinder body 10J inserted is fixed at a middle of the cylinder body 10J in the central axis direction. In other words, in the cylinder 10E, the cylinder body 10J is inserted into the screw member 10B having the outer peripheral surface formed with the screw thread and fixed.

The open end 10L of the cylinder body 10J is closed by the rod guide. The piston is slidably inserted in the cylinder body 10J. The rod 10F is formed into a columnar shape and has a proximal end connected to the piston. The rod 10F is inserted through the rod guide, so that a distal end thereof protrudes through the open end 10L out of the cylinder body 10J. In other words, the rod 10F is inserted into the cylinder body 10J.

A rod-side joint 100 is coupled to the distal end of the rod 10F. The rod-side joint 10G is formed with a first through hole (not illustrated) extending therethrough in a direction perpendicular to a central axis of the rod 10F. A hydraulic fluid and a compressed gas are enclosed in the cylinder body 10J. When the damper 10A is contracted so that the compressed gas enclosed in the cylinder body 10J is compressed, an expansion force of the compressed gas works in an extending direction.

The damper 10A is a compression damper in which a damping force generated during an extending operation is smaller than a damping force generated during a contracting operation. The extending operation of the damper 10A refers to an operation which increases an amount of protrusion of the rod 10F out of the open end 10L of the cylinder body 10J and an overall length of the damper 10A. The contracting operation of the damper 10A refers to an operation which reduces an amount of protrusion of the rod 10F out of the open end 10L of the cylinder body 10J and the overall length of the damper 10A.

The following will describe a mechanism of generating a damping force by the damper 10A. Since the mechanism has a known structure, diagrammatic representation is eliminated. The cylinder body 10J has an interior divided by the piston into a rod side pressure chamber in which the proximal end of the rod 10F is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the extending/contracting operation of the damper 10A. Furthermore, the piston is formed with a communication path communicating via a check valve with both pressure chambers. The check valve allows the hydraulic fluid to flow from the rod side pressure chamber to the counter-rod side pressure chamber and blocks reverse flow of the hydraulic fluid. Accordingly, the damper 10A has two flow paths of the hydraulic fluid from the rod side pressure chamber to the counter-rod side pressure chamber during the extending operation, that is, one flow path including the orifice and the other flow path including the communication path. On the other hand, the damper 10A has only one flow path of the hydraulic fluid from the counter-rod side pressure chamber to the rod side pressure chamber through the orifice during the contracting operation. Accordingly, the damping force generated by the damper 10A during the extending operation is smaller than the damping force generated by the damper 10A during the contracting operation.

The length adjusting member 10C includes a cylinder member body 10K and a cylinder member side joint 10H. The cylinder member body 10K is bottomed and formed into a cylindrical shape. The cylinder member body 10K has an inner peripheral surface formed with a screw thread. The cylinder member body 10K has a dimension in the central axis direction slightly smaller than that of the cylinder body 10J. The cylinder member side joint 10H is coupled to an outside of the bottom of the cylinder member body 10K which is the other end thereof. The cylinder member side joint 10H is formed with a second through hole (not illustrated) extending therethrough in a direction perpendicular to the central axis of the cylinder member body 10K. The screw member 10B into which the cylinder body 10J is inserted and fixed is screwed into the length adjusting member 10C from an open one end of the cylinder member body 10K. In this case, the distal end of the rod 10F of the damper 10A protrudes out of the open end of the cylinder member body 10K of the length adjusting member 10C. The length adjusting member 10C is rotatable relative to the screw member 10B. As a result, the length adjusting member 10C and the screw member 10B are radially telescopic in the central axis direction.

The nut member 10D has a. predetermined thickness and is annular in shape. The nut member 10D has a regular hexagonal profile in a planar view from above. The nut member 10D has an annular hole that is circular in shape. The nut member 10D has a screw thread formed on an inner peripheral surface of the hole. The nut member 10D abuts against the one end of the cylinder member body 10K of the length adjusting member 10C and is screwed onto the screw member 10B. In other words, the nut member 10D is screwed onto the cylinder 10E. The nut member 10D is rotatable relative to the screw member 10B. As a result, the nut member IOD is rotated about the central axis of the screw member 10B thereby to be movable in the central axis direction of the screw member 10B.

The first base 11 includes a first flat plate 11A, a first slip preventing part 11B serving as a friction member and a pair of first joints 11C. The first flat plate 11A is formed into a flat plate shape and extends in one direction. The first flat plate 11A has a rectangular profile. The first flat plate 11A has two pairs of opposed sides in the rectangular shape. One pair of opposed sides are longer sides and the other pair of opposed sides are shorter sides. The first slip preventing part 11B is formed into a flat plate shape and extends in one direction. The first slip preventing part 11B has a rectangular profile that is substantially same as that of the first flat plate 11A. The first slip preventing part 11B is attached to one end surface of the first flat plate 11A while the outer shape of first slip preventing part 11B is matched with the outer shape of the first flat plate 11A.

The first joints 11C are each formed into a flat plate shape. The first joints 11C extend in a direction opposed to the one end surface of the first flat plate 11A with respective proximal ends thereof being connected to the longer sides of the first flat plate 11A. The first joints 11C have respective distal edges each formed into an arc shape extending from both ends of the longer side of the first flat plate 11A toward a central part of the longer side. The first joints 11C have respective third through holes 11D each formed near the distal edge of the central part of the flat plate shape so as to extend therethrough in a direction perpendicular to the flat plate shape. The third through holes 11D are located coaxially with each other.

The cylinder member side joint 10H of the length adjusting member 10C is disposed between the first joints 11C of the first base 11. The cylinder member side joint 10H has a second through hole (not illustrated) formed therethrough to be coaxial with the third through holes 11D. A first coupling shaft 11E formed into a columnar shape is inserted through the second through hole and the third through holes 11D, whereby the first base 11 is rotatably coupled to the other end of the cylinder member body 10K of the length adjusting member 10C.

The second base 12 includes a second flat plate 12A, a second slip preventing part 12B serving as a friction member and a pair of second joints 12C. The second flat plate 12A is formed into a flat plate shape and extends in one direction. The second flat plate 12A has a rectangular profile. The second flat plate 12A has two pairs of opposed sides in the rectangular shape. One pair of opposed sides are longer sides and the other pair of opposed sides are shorter sides. The second slip preventing part 12B is formed into a flat plate shape and extends in one direction. The second slip preventing part 12B has a rectangular profile that is substantially same as that of the second flat plate 12A. The second slip preventing part 12B is attached to one end surface of the second flat plate 12A while the outer shape of the second slip preventing part 12B is matched with the outer shape of the second. flat plate 12A.

The second joints 12C are each formed into a flat plate shape. The second joints 12C extend in a direction opposed to the one end surface of the second flat plate 12A with respective proximal ends thereof being connected to the longer sides of the second flat plate 12A. The second joints 12C have respective distal edges each formed into an arc shape extending from both ends of the longer side of the second flat plate 12A toward a central part of the longer side. The second joints 12C have respective fourth through holes 12D each formed near the distal edges of the central part of the flat plate shape so as to extend therethrough in a direction perpendicular to the flat plate shape. The fourth through holes 12D are located coaxially with each other.

The rod-side joint 10G is disposed between the second joints 12C of the second base 12. The rod-side joint 10G has a first through hole (not illustrated) formed therethrough to be coaxial with the fourth through holes 12D. A second coupling shaft 12E formed into a columnar shape is inserted through the first through hole and. the fourth through holes 12D, whereby the second base 12 is rotatably coupled to the distal end of the rod 10F. The overturn preventing device is thus constructed.

In the overturn preventing devices as illustrated in FIG. 1(A), when the damper 10A is screwed deepest into the length adjusting member 10C and the damper 10A is contracted most, an upper end of the length adjusting member 10C is level with or is located lower than a lower end of the rod-side joint 10G of the damper 10A.

The following will describe a manner of mounting the overturn preventing device between the top surface 11J of the furniture F installed on the installation surface with the back surface 1B being opposed to the wall surface W, and the ceiling C.

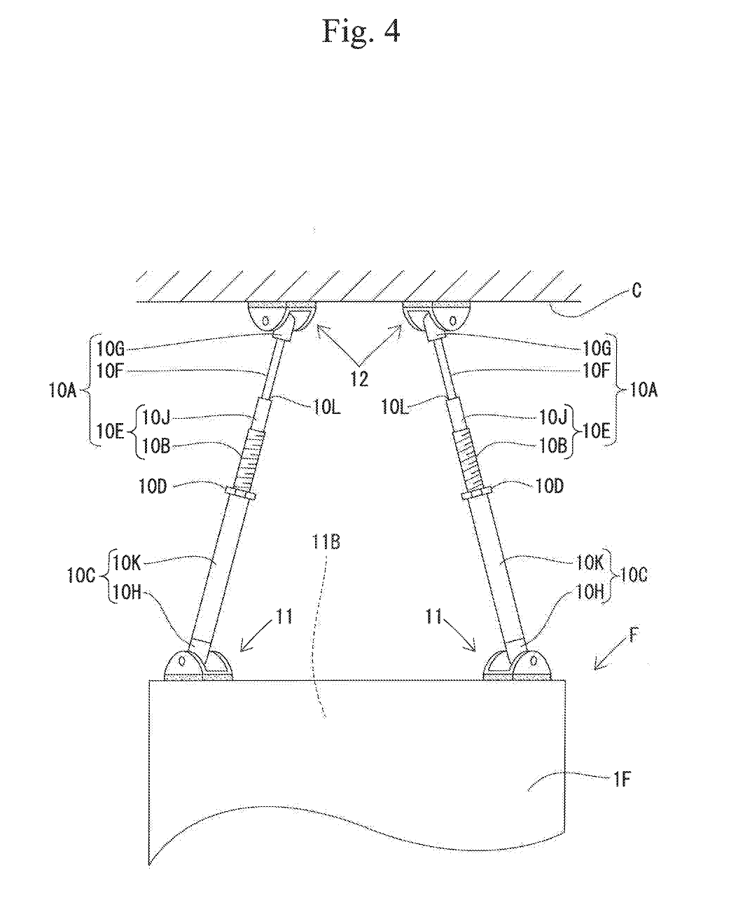

A pair of overturn preventing devices is mounted between the ceiling C and the top surface 113 of the furniture F (refer to FIG. 4). First, as illustrated in FIGS. 2 and 3, the screw member 10B is rotated relative to the length adjusting member 10C so that a dimension of part of the screw member 10B is changed, which part protrudes from the cylinder member body 10K of the length adjusting member 10C. Then, an overall length of the overturn preventing device is adjusted to the length suitable to the dimension between the ceiling C and the top surface 1U of the furniture F. Here, the overall length of the overturn. preventing device refers to a distance L1 or L2 between the lower end surface of the first slip preventing part 11B and the upper end surface of the second slip preventing part 12B in the case where flat surfaces of the first flat plate 11A of the first base 11 and the second flat plate 12A of the second base 12 are directed at right angle to the central axis of the damper 10A (refer to FIGS. 1A and 1B) In the adjustment, the overall length of the overturn preventing device is set to be larger than the distance between the ceiling C and the top surface 1U of the furniture F where the overturn preventing device is to be mounted.

Next, the nut member 10D is rotated relative to the screw member 10B so that the nut member 10D is caused to abut. against the one end of the cylinder member body 10K of the length adjusting member 10C and tightened. Then, the first slip preventing parts 11B of the first bases 11 are caused to abut against the right and left ends at the rear side of the upper surface 1U of the furniture F. Then, the dampers 10A are contracted so that the second bases 12 are disposed in front of the first bases 11. Furthermore, as illustrated in FIG. 4, the second bases 12 are disposed at a right-left center side of the furniture F as compared with the first bases 11. Then, the second slip preventing parts 12B of the second bases 12 are caused to abut against the ceiling C. In other words, the first slip preventing parts 11B of the first bases 11 abut against the top surface 1U of the furniture F, and the second slip preventing parts 12B of the second bases 12 abut against the ceiling C. In other words, the first bases 11 and the second bases 12 abut against the top surface 1U of the furniture F and the ceiling C, respectively. Thus, the paired overturn preventing devices are mounted between the ceiling C and the top surface 1U of the furniture F while being inclined with upper parts being located in front of lower parts and further with the upper parts being located at the right-left center side of the furniture F with respect to the lower parts. In this case, it is preferable that the central axis of the damper 10A is inclined in an angular range from 15° to 25° relative to the vertical direction.

Since the expansion force of the compressed gas enclosed in the cylinder body 10J normally generates a force in an extending direction, each overturn preventing device is in a stretched state between the ceiling C and the top surface 1U of the furniture F. In each overturn preventing device, the first slip preventing part 11B of the first base 11 abuts against the top surface 1U of the furniture F in a nonslip state, and the second slip preventing part 12B of the second base 12 abuts against the ceiling C in a nonslip state. As a result, the first base 11 need not be fixed to the top surface 1U of the furniture F, and the second base 12 need not be fixed to the ceiling C.

The working of the overturn preventing device will now be described.

In the paired overturn preventing devices mounted between the ceiling C and the top surface 1U of the furniture F, when the furniture F is tilted forward by shaking earthquake or the like, the first bases 11 come close to the second bases 12 so that the dampers 10A are contracted thereby to generate a damping force (refer to FIGS. 2 and 3). As a result, the overturn preventing devices can damp the force to tilt the furniture F forward, thereby preventing the furniture F from being overturned forward.

Furthermore, when the furniture F is tilted rightward by shaking earthquake or the like, the first base 11 of the overturn preventing device mounted at a left side of the top surface 1U of the furniture F comes close to the second base 12 so that the damper 10A is contracted thereby to generate a damping force (refer to FIG. 4) As a result, the overturn preventing device can damp the force to tilt the furniture F rightward, thereby preventing the furniture F from being overturned rightward.

Furthermore, when the furniture F is tilted leftward by shaking earthquake or the like, the first base 11 of the overturn preventing device mounted at a right side of the top surface 1U of the furniture F comes close to the second base 12 so that the damper 10A is contracted thereby to generate a damping force (refer to FIG. 4) . As a result, the overturn preventing device can damp the force to tilt the furniture F leftward, thereby preventing the furniture F from being overturned leftward.

As described above, the cylinder 10E having the outer peripheral surface formed with the screw thread is screwed into the cylinder member body 10K of the length adjusting member 10C having the inner peripheral surface formed with the screw thread. As a result, even when an earthquake occurs under a condition where the overturn preventing device is mounted between the ceiling C and the top surface 1U of the furniture F and the furniture F is vibrated by shaking of the earthquake with the result that the overturn preventing device is contracted between the ceiling C and the top surface 1U of the furniture F, the cylinder 10E is not pushed into the cylinder member body 10K of the length adjusting member 10C, so that the overall length of the overturn preventing device is not reduced. Accordingly, the overturn preventing device can be prevented from dropping from between the ceiling C and the top surface 1U of the furniture F. Furthermore, the overall length of the overturn preventing device can be adjusted to a desired length by rotating the cylinder 10E relative to the length adjusting member 10C. As a result, even when the distance between the ceiling C and the top surface 1U of the furniture F differs from one case to another, the overturn preventing device can be mounted by adjusting the overall length thereof to the length suitable to the dimension between the ceiling C and the top surface 1U of the furniture F.

Furthermore, when the furniture F is vibrated due to an earthquake, the vibration of the furniture F can be damped by the damper 10A. As a result, the overturn preventing device can continuously suppress vibration of the furniture F as compared with the case where the vibration of the furniture F is absorbed by only a spring. Consequently, the overturn preventing device can reduce breakage of the furniture F and its surroundings due to a repeated collision of the furniture F and its surroundings by a continuous vibration of the furniture F.

Accordingly, the overturn preventing device can successfully prevent the furniture F from overturn caused by shaking of earthquake.

Furthermore, the cylinder 10E includes the cylinder body 10J into which the rod 10F is inserted, and the screw member 10B into which the cylinder body 10J is inserted to be fixed and which has the outer peripheral surface formed with the screw thread thereby to be screwed into the cylindrical member body 10K of the length adjusting member 10C. As a result, the length of the screw member 10B can be set irrespective of the length of cylinder 10E. Consequently, the dimension capable of mounting the overturn preventing device can be broadened by changing the length of the screw member 10B without preparing a plurality of dampers 10A. having different lengths.

Furthermore, the overturn preventing device includes the nut member 10D which is screwed onto the cylinder 10E and abuts against one end of the cylindrical member body 10K of the length adjusting member 10C. As a result, after the cylinder 10E has been rotated relative to the length adjusting member 10C and the overall length of the overturn preventing device has been adjusted to a desired value, the nut member 10D can be tightened onto the cylindrical member body 10K of the length adjusting member 10C. This can suppress an inadvertent movement of the cylinder 10E relative to the length adjusting member 10C. Accordingly, when an earthquake occurs under the condition where the overturn preventing device is mounted between the ceiling C and the top surface 113 of the furniture F, the cylinder 10E and the length adjusting member 10C are not moved relative to each other by the vibration caused by the earthquake Accordingly, this overturn preventing device can suppress fatigue breakage of the cylinder 10E and the cylindrical member body 10K of the length adjusting member 10C and breakage of the screw threads formed on the cylinder 10E and the cylindrical member body 10K of the length adjusting member 10C.

Furthermore, the first base 11 and the second base 12 respectively have the first slip preventing part 11B and the second slip preventing part 12B which abut against the top surface 1U of the furniture F and the ceiling C respectively. As a result, materials of the first and second slip preventing part s 11B and 12B can be rendered suitable for the materials of the top surface 1U of the furniture F and the ceiling C. Consequently, the overturn preventing device can successfully be mounted between the ceilings C and the top surfaces 1U of pieces of furniture F made of various materials.

Furthermore, when the damper 10A is screwed deepest into the length adjusting member 10C and the damper 10A is contracted most, the upper end of the length adjusting member 10C is level with or is located lower than the lower end of the rod-side joint 10G of the damper 10A. As a result, since the stroke of the damper 10A is not interrupted, the damper 10A can reliably be operated. Furthermore, a dimension of a part of the cylinder 10E screwed into the length adjusting member 10C can be rendered longer in this overturn preventing device. In other words, since an overlapped dimension of the length adjusting member 10C and the cylinder 10E can be increased, the strength of the cylinder 10E can be improved. Furthermore, in the case where the overall length of the overturn preventing device is rendered maximum by adjusting the dimension of a part of the cylinder 10E screwed into the cylindrical member body 10K of the length adjusting member 10C, the dimension of a part of the cylindrical member body 10K into which the cylinder 10E is not screwed can be rendered minimum. As a result, when an earthquake occurs under the condition where the overturn preventing device is mounted between the ceiling C and the top surface 1U of the furniture F, the cylindrical member body 10K can be rendered less likely to be buckled even when compressed between the ceiling C and the top surface 1U of the furniture F. in other words, changes of strength of the cylindrical member body 10K can be rendered smaller between the case where the overall length of the overturn preventing device is maximum and the case where the overall length of the overturn preventing device is minimum.

### Second Embodiment

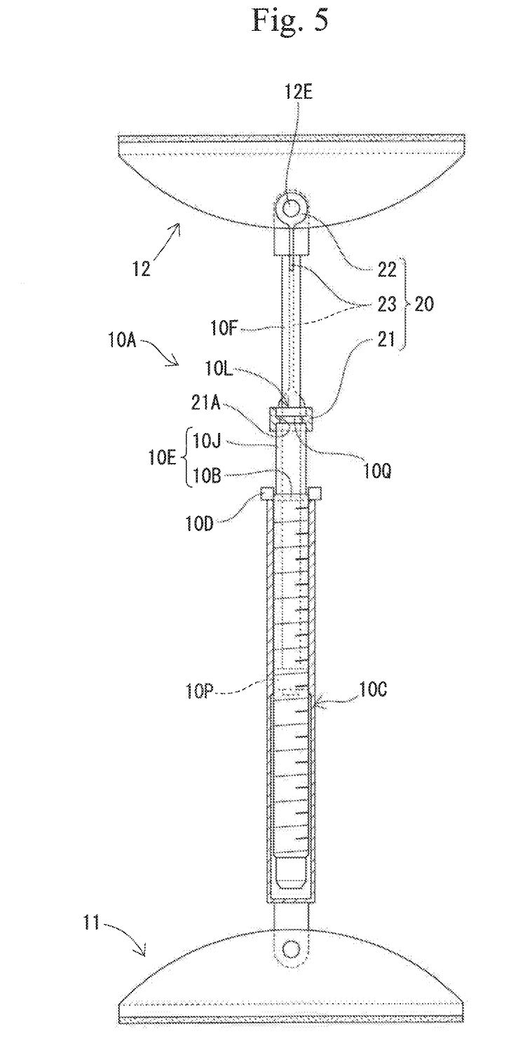

Next, a second embodiment will be described with reference to FIG. 5 etc. The overturn preventing device of the second embodiment differs from that of the first embodiment in the provision of a stopping member which stops the damper from extension. Other construction is substantially same as that. of the first embodiment and has the same function. Accordingly, identical or similar parts in the second embodiment are labelled by the same reference symbols as those in the first embodiment and detailed description of these parts will be eliminated.

Though the damper 10A in this embodiment is a hydraulic damper which encloses the hydraulic fluid and compressed gas in the cylinder 10E as in the first embodiment, the damper 10A in this embodiment includes a piston 10P illustrated in FIG. 5 as a specific component,. The piston 10P is housed in the cylinder 10E to be slidable in a direction of the central axis, and a proximal end of the rod 10F is connected to the piston 10P. The damper 10A has a swaging groove 10Q formed in the open end 10L of the cylinder 10E. The swaging groove 10Q is formed when a rod guide (not illustrated) is fixed by swaging.

The overturn preventing device of the second embodiment includes a stopping member 20 as illustrated in FIG. 5. The stopping, member 20 includes a cylinder-side engagement part 21, rod-side engagement parts 22 and coupling parts 23. The cylinder-side engagement part 21 and the rod-side engagement. parts 22 are engaged with the outer peripheral surface of the cylinder 10E and the second base 12 side respectively, thereby to stop the damper 10A from extension. More specifically, the cylinder-side engagement part 21 is formed into a cylindrical shape and engaged with an outer peripheral surface of the open end 10L of the cylinder 10E. Engagement positions of the cylinder-side and rod-side engagement parts 21 and 22 are increasingly distanced from each other according to extension of the damper 10A. The cylinder-side engagement part 21 is formed with a protrusion 21A protruding from an inner wall thereof to a central direction. The protrusion 21A of the cylinder-side engagement part 21 is fitted into the swaging groove 10Q formed in the open end 10L of the cylinder 10E, whereby the cylinder-side engagement part 21 is engaged with the cylinder 10E. in other words, the cylinder-side engagement part 21 is engaged by the use of the swaging groove 10Q in this embodiment , A pair of rod-side engagement parts 22 is each formed into an annular shape and respectively engaged with both ends of a second coupling shaft 12E of the second base 12. The coupling parts 23 are formed to rise from the cylinder-side engagement part 21 toward the rod-side engagement parts 22 to be coupled to the rod-side engagement parts 22.

In the damper 10A while the rod 10F is disposed at the upper side thereof and the cylinder 10E is disposed at the lower side thereof, the stopping member 20 stops the damper 10A from extension at a length thereof in a range between the length when the piston 10P is located at an upper end in the hydraulic fluid and the length when the piston 10P is located at a lower end in the hydraulic fluid, namely, at a length not more than the length when the piston 10P is located at the upper end in the hydraulic fluid. In this embodiment, the stopping member 20 stops the damper 10A from extension at a middle length between the length when the piston 10P is located at the upper end in the hydraulic fluid and the length when the piston 10P is located at the lower end in the hydraulic fluid. In other words, the stopping member 20 stops the damper 10A from extension at the length when the piston 10P is located at the center of a slidable range of the piston immersed in the hydraulic fluid. In the damper 10A of this embodiment, a range of about 50 mm both above and below the center is ensured as a slidable range of the piston immersed in the hydraulic fluid. In other words, the stroke at which the damper 10A can exhibit a proper performance is about 100 mm in this embodiment.

The overturn preventing device constructed as described above is mounted between the top surface 113 of the furniture F and the ceiling C in the following manner. Before the mounting of the overturn preventing device, the screw member 10B of the cylinder 10E is screwed deepest into the length adjusting member 10C as illustrated in FIG. 5, so that the overturn preventing device is in the shortest state. In this state, the first base 11 is caused to abut against the top surface 1U of the furniture F.

Next, the overturn preventing device is extended. This extension is carried out by the length adjusting member 10C. More specifically, the length adjusting member 10C and the damper 10A are moved relative to each other so that the length between the first base 11 and the cylinder 10E is adjusted. In an actual work, the cylinder 10E is rotated in a state where the first base 11 is in abutment against the top surface 1U of the furniture F. With this, the length adjusting member 10C which is threadingly engaged with the screw member 10B is moved relative to the damper 10A. As a result, the damper 10A is pushed upward. With this, the second base 12 is also pushed upward. Thus, the length is adjusted by the length adjusting member 10C and the second base 12 is caused to abut against the ceiling C. In this case, since the length adjusting member 10C is extended while the damper 10A is stopped from extension, the second base 12 abuts against the ceiling C without change in the overall length of the damper 10A. In other words, the piston 10P remains at the center between the upper end position and the lower end position in the hydraulic fluid, so that strokes of about 50 mm are ensured in both upward and downward directions.

Then, the length adjusting member 10C and the cylinder 10E are fixed to each other by the nut member 10D. Finally, the damper 10A is released from stop of the extension by the stopping member 20, so that the biasing force of the damper 10A is applied to the top surface 1U of the furniture F and the ceiling C. More specifically, the rod-side engagement parts 22 of the stopping member 20 are detached from the second coupling shaft 12E. The release of the damper 10A may be carried out by detaching the cylinder-side engagement part 21. Since the second base 12 is already in abutment against the ceiling C when the damper 10A is released from extension stop by the stopping member 20, the damper 10A is not extended. For example, when the damper 10A is released from the extension stopped state in a state where the second base 12 is not contact with the ceiling C, the damper 10A is extended at once by gas pressure of the compressed gas with the result that the second base 12 collides against the ceiling C. In the embodiment, however, since the damper 10A is released from the extension stopped state after the second base 12 has abutted against the ceiling, the collision of the second base 12 against the ceiling C by the extension of the damper 10A does not occur.

When the overturn preventing device is to be detached, the above-described procedure is performed in reverse order. More specifically, at first, the extension of the damper 10A is stopped by the stopping member 20. Subsequently, the nut member 10D is loosened so that the length adjusting member 10C and the cylinder 10E are released from the fixed state. Finally, the cylinder 10E is rotated so that the distance between the first base 11 and the cylinder 10E is adjusted to be shortened, and the second base 12 is separated from the ceiling C.

As described above, the overturn preventing device includes the stopping member 20 which stops the damper 10A from extension. The damper 10A is the hydraulic damper including the cylinder 10E filled with the hydraulic fluid and the piston 10P which is housed in the cylinder 10E to be slidable in the central axis direction and to which the proximal end of the rod 10F is coupled. And, in the damper 10A while the rod 10F is disposed at the upper side thereof and. the cylinder 10E is disposed at the lower side thereof, the stopping member 20 stops the damper 10A from extension at a length of the damper 10A not more than a length when the piston 10P is located at an upper end in the hydraulic fluid. As a. result, the length with which a damping force is properly generated is ensured by the stopping member 20. Accordingly, the overturn preventing device can be mounted between the top surface 1U of the furniture F and the ceiling C while a proper damping force can reliably be generated by the damper 10A.

Furthermore, in the damper 10A while the rod 10F is disposed at the upper side thereof and the cylinder 10E is disposed. at the lower side thereof, the stopping member 20 stops the damper 10A from extension at a middle length of the damper 10A between the length when the piston 10P is located at the upper end in the hydraulic fluid and another length when. the piston 10P is located at the lower end in the hydraulic fluid. Accordingly, even when the furniture F is tilted by shaking with the result that the damper 10A is expanded or contracted either in the expansion direction or in the contraction direction, the piston 10P is moved in the hydraulic fluid, so that the damper 10A can exert a proper damping force.

Furthermore, the stopping member 20 includes the cylinder-side engagement part 21, the rod-side engagement part 22 and the coupling parts 23. The cylinder-side engagement. part 21 and the rod-side engagement parts 22 are respectively engaged with the positions which are increasingly distanced from each other according to extension of the damper 10A. The coupling parts 23 couple the cylinder-side and rod-side engagement parts 21 and 22. As a result, the damper 10A can reliably be stopped from extension.

Furthermore, the cylinder-side engagement part 21 is formed into the cylindrical shape and includes the protrusion 21A protruding in the center direction from the inner wall. The protrusion 21A is engaged with the swaging groove 10Q formed in the outer peripheral surface of the open end 10L of the cylinder 10E. As a result, the cylinder-side engagement part 21 can be engaged with the cylinder 10E side easily and reliably.

Furthermore, the paired rod-side engagement parts 22 are each formed into the annular shape and are respectively engaged with both ends of the second coupling shaft 12E of the second base 12. As a result, the rod-side engagement parts 22 can respectively be engaged with both ends of the second coupling shaft 12E easily and reliably.

### Other Embodiments

The present invention should not be limited to the embodiments described above with reference to the drawings, but the technical scope of the invention encompasses the following embodiments, for example,
(1) Although the overturn preventing device is mounted on the furniture in each of the first and second embodiments, the overturn preventing device may be mounted on an article such as a bookshelf or a refrigerator which has a possibility of overturn by shaking of earthquake or the like.
(2) Although the overturn preventing device i s mounted on the furniture installed on. the installation surface with its back surface being opposed to the wall surface in each of the first and second embodiments, the overturn preventing device may be mounted on the furniture or the like installed on the installation surface without being adjacent to the wall surface.
(3) Although the compression damper which generates a damping force only when contracted is used in each of the first and second embodiments, a two-way damper which generates a damping force in both operations when contracted and when expanded may be used.
(4) Although the damper enclosing a hydraulic fluid and compressed gas in the cylinder body is used in each of the first and second embodiments, a fluid-pressure damper enclosing another fluid or another type of damper may be used as long as it can exert a predetermined damping force in a contracting operation.
(5) In each of the first and second embodiments, the compressed gas is enclosed in the cylinder body so that an expansion force of the compressed. gas acts in an extension direction. However, a force acting in the extension direction may be generated by another manner. Furthermore, the compressed gas or the like may not be enclosed in the cylinder body, and no force may act in the extension direction.
(6) Although the cylinder body is mounted at the top surface side of the furniture and the rod is mounted on the ceiling side in each of the first and second embodiments, the cylinder body may be mounted at the ceiling side and the rod may be mounted at the top surface side of the furniture.
(7) Although the nut member is provided in each of the first and second embodiments, the nut member may not be provided.
(8) Although the nut member formed into a regular hexagonal profile is used in each of the first and second embodiments, a nut member having another profile, such as a nut with a knurled outer peripheral surface, a flynut, a square nut or the like may be used.
(9) Although the screw member is provided in each of the first and second embodiments, the screw member may not be provided. In this case, a screw thread is formed on the outer peripheral surface of the cylinder body and is screwed into the cylindrical member body of the length adjusting member.
(10) Although the first slip preventing part and the second slip preventing part are provided in each of the first and second embodiments, double-stick paper or adhesive agent may be used as the first slip preventing part and the second slip preventing part to be affixed to the top surface of the furniture or the ceiling.
(11) Although a pair of overturn preventing devices are mounted between the ceiling and the top surface of the furniture in the first embodiment, a single, three or more overturn preventing devices may be mounted between the ceiling and the top surface of the furniture.
(12) The forms of the first and second bases should not be limited to those of the first and second embodiments.
(13) Although an example provided with the stopping member is presented as the second embodiment, the overturn preventing device may not be provided with the stopping member. Furthermore, although the stopping member may be flexible, it is preferable that the stopping member is not easily deformed (extended) with respect to the extension direction.
(14) The second embodiment exemplifies the configuration that the stopping member is engaged with the outer peripheral surface of the cylinder and the second coupling shaft serving as a rotating shaft member at the second base side. However, the shape of the stopping member, a part to be engaged, an engaging manner and the like should not be limited as long as extension of the damper can be stopped.
(15) The second embodiment exemplifies the configuration that, in the damper while the rod is disposed at the upper side and the cylinder is disposed at the lower side, the stopping member stops the damper from extension at the middle length between the length when the piston is located at the upper end in the operating fluid and another length when the piston is located at the lower end in the operating fluid. In this case, the term, “middle” does not have to be strictly middle.

### EXPLANATION OF REFERENCE SYMBOLS

C . . . ceiling; F . . . furniture (article) ; 10A . . . damper; 10B . . . screw member; 10C . . . length adjusting member; 10D . . . nut member; 10E . . . cylinder; 10F . . . rod; 10G . . . rod-side joint; 10J . . . cylinder body; 10L . . . open end; 10M . . . closed end; 11 . . . first base (base); 11B . . . first slip preventing part (friction member) ; 12 . . . second base (base) ; 12B . . . second slip preventing part (friction member); and 20 . . . stopping member.

1. An overturn preventing device comprising:
a damper including a bottomed cylinder having an outer peripheral surface formed with a screw thread, and a rod, the cylinder having two ends one of which is an open end and the other of which is a closed end, the rod being inserted into the cylinder and having a distal end protruding out of the open end of the cylinder;
a length adjusting member having a first end and a second end, the first end having an opening, the length adjusting member having an inner peripheral surface formed with a screw thread so that the cylinder is screwed through the first end into the length adjusting member; and
a pair of bases rotatably coupled to the second end of the length adjusting member and the distal end of the rod respectively, the bases being configured to abut against a top surface of an article installed on an installation surface and a ceiling respectively.

2. The overturn preventing device according to claim 1, wherein the cylinder includes a cylinder body into which the rod is inserted, and a screw member into which the cylinder body is inserted to be fixed, the screw member having an outer peripheral surface formed with a screw thread thereby to be screwed into the length adjusting member.

3. The overturn preventing device according to claim 1, further comprising a nut member screwed onto the cylinder and abutting against the first end of the length adjusting member.

4. The overturn preventing device according to claim 1, wherein the base has a friction member which abuts against the ceiling or the top surface of the article.

5. The overturn preventing device according to claim 1, wherein when the damper is screwed deepest into the length adiusting member and the damper is contracted most, an upper end of the length adjusting member is level with or is located lower than a. lower end of a rod-side joint of the damper.

6. The overturn preventing device according to claim 1, further comprising a stopping member which stops the damper from extension, wherein:
the damper is a fluid pressure damper which encloses an operating fluid in the cylinder and has a piston housed in the cylinder to be slidable in a direction of a central axis of the cylinder, the rod having a proximal end coupled to the piston;
the damper is disposed so as to be extendable/contractable while applying a biasing force in an extending direction and generates a damping force by the extending/contracting operation; and
in the damper while the rod is disposed at an upper side thereof and the cylinder is disposed at a lower side thereof, the stopping member stops the damper from extension at a length of the damper not more than a length when the piston is located at an upper end in the operating fluid.

7. The overturn preventing device according to claim 6, wherein, the stopping member stops the damper from extension at a middle length of the damper between the length when the piston is located at the upper end in the operating fluid and another length when the piston is located at a lower end in the operating fluid

8. The overturn preventing device according to claim 2, further comprising a nut. member screwed onto the cylinder and abutting against the first end of the length adjusting member.

9. The overturn preventing device according to claim 2, wherein the base has a friction member which abuts against the ceiling or the top surface of the article.

10. The overturn preventing device according to claim 2, wherein when. the damper is screwed deepest into the length adjusting member and the damper is contracted most, an upper end of the length adjusting member is level with or is located lower than a lower end of a rod-side joint of the damper

11. The overturn preventing device according to claim 2, further comprising a stopping member which stops the damper from extension, wherein:
the damper is a fluid pressure damper which encloses an operating fluid in the cylinder and has a piston housed in the cylinder to be slidable in a direction of a central axis of the cylinder, the rod having a proximal end coupled to the piston;
the damper is disposed so as to be extendable/contractable while applying a biasing force in an extending direction and generates a damping force by the extending; contracting operation; and
in the damper while the rod is disposed at an upper side thereof and the cylinder is disposed at a lower side thereof, the stopping member stops the damper from extension at a length of the damper not more than a length when the piston is located at an upper end in the operating fluid.

12. The overturn preventing device according to claim 11, wherein, the stopping member stops the damper from extension at a middle length of the damper between the length when the piston is located at the upper end in the operating fluid and another length when the piston is located at a lower end in the operating fluid.
